(19) United States
(12) Patent Application Publication
(10) Pub. No.: US 2011/0218829 A1
(43) Pub. Date: Sep. 8, 2011

(54) COMPUTER BASED METHOD FOR PREVENTING FINANCIAL LOSS DUE TO DISABILITY FOR PARTICIPANTS

(75) Inventor: Paul Hinson, Rockport, TX (US)

(73) Assignee: PENSION ADVISORY GROUP, INC., Rockport, TX (US)

(21) Appl. No.: 13/149,621

(22) Filed: May 31, 2011

Related U.S. Application Data
(63) Continuation of application No. 12/573,020, filed on Oct. 2, 2009.
Application No. 12/573,020 is a continuation-in-part of application No. 12/501,326, filed on Jul. 10, 2009, now abandoned.
Application No. 12/501,326 is a continuation-in-part of application No. 10/908,419, filed on May 11, 2005, now abandoned.
(60) Provisional application No. 60/570,889, filed on May 13, 2004.

(51) Int. Cl. G06Q 40/00

(52) U.S. Cl. 705/4

(57) ABSTRACT

A system and method for preventing financial loss due to disability of participants in a retirement plan according to an insurance contract. One or more computers are programmed within a network to collate data from one or more databases according to the terms of an insurance contract. The insurance contract pays benefits into the retirement plan trust upon the disability of a plan participant. The benefits are treated as income or gain under the plan and are allocated to the participant's account. Benefits are distributable only upon attainment of the participant's normal retirement age. The administration of a retirement plan is carried out according to a computer based method and within a computer based system.

### CROSS REFERENCE TO RELATED APPLICATIONS

This application is a continuation-in-part of U.S. application Ser. No. 12/501,326, which is a continuation-in-part of U.S. application Ser. No. 10/908,419, filed Jun. 11, 2005, and which claims benefit of U.S. provisional application, filed May 13, 2004, each and all of which applications are expressly incorporated by reference herein.

### FIELD

This disclosure, in a broad sense, is directed towards a method and system of insuring against financial loss due to disability. This disclosure further relates to a computer-based data processing method that will automatically generate the appropriate disability insurance premium amounts for a unisex-rated pension disability insurance contract that is designed to continue funding retirement plan contributions for Defined Contribution retirement plan participants if they become disabled while they are actively employed and covered by said disability insurance. This disclosure also relates to methods of evaluating risks and accurately pricing of insurance coverage which will enable an insurer to profitably offer disability insurance within such a retirement plan while complying with the law set forth in Arizona Governing Comm. v. Norris, 463 U.S. 1073 (1983).

### BACKGROUND

Many different retirement plans exist on the market today. However, the defined contribution or “401 (k)” plan currently is the most popular type of plan for the American worker to save money for retirement.

There are currently over 30 million individual 401 (k) plan participants in the United States. These plans have over one trillion dollars in assets, which exceeds the total assets in all other types of plans combined. Approximately 88% of these plans permit the employee, to a limited extent, to choose and or modify the particular securities in which the employee's money is invested.

A 401 (k) retirement plan is one that is funded primarily by employee contributions from annual salary or wages, and which also may have an employer matching component whereby the employer will contribute a matching percentage of the employee's annual contribution to the plan, and further may include a discretionary profit-sharing component. A significant benefit of the 401 (k) plan is its tax-deferred nature: not only are contributions deducted from the employee's pre-tax gross income, but gains from the investments in the plan also grow tax-free until such time as withdrawals are made.

Among the advantages of 401 (k) plans are that since the employee does not pay any income tax on the percentage of his or her compensation that is contributed to the plan, such contributions effectively realize an immediate percentage “gain” defined by the employee's current tax bracket (which amount the employee would otherwise have to pay in income tax if the employee took the compensation in cash). Additionally, neither employer matching contributions nor employer discretionary profit-sharing contributions are subject to taxation when made to the plan. Further, the employee typically is able to choose among a number of different investment securities such as mutual stock funds, bond funds, cash management funds, and the like in which to invest the contributed funds, and normally he or she can move funds from one security to another thereby changing the relative percentage contributed to the different funds of the plan on an ongoing basis.

Still further, should the employee separate from his or her employer, unlike a pension or defined benefit plan, the employee's vested 401 (k) funds may be “rolled over” either to a personal IRA (Individual Retirement Account) or to the 401 (k) plan of a new employer.

One problem with current 401 (k) plans occurs when an employee becomes disabled, e.g. as a result of injury or illness, and is no longer able to work either permanently or for an extended period of time. During this period of disability, the employee is not receiving regular compensation and therefore cannot continue to make contributions to the retirement plan from periodic paychecks. In fact, even if the disabled employee had available funds from which to make contributions to the retirement plan, such would normally not be permitted as the disabled employee is not an active worker and therefore would not be eligible to make ongoing contributions.

Of course, many employers provide short term and long term disability insurance for their employees. Such insurance, however, typically provides only a fraction of the income received from the disabled employee's regular job, is usually considered to be taxable income if the employer has paid the insurance premiums on behalf of the employee, and is only payable during the period that the employee is disabled-which by definition is usually at time during which the disabled individual is also incurring significant additional healthcare related expenses. Consequently, such disability insurance does not make up for the loss of expected growth in the employee's retirement plan over the long term caused by disability, which may be tens of thousands of dollars or more depending upon the age of the employee at the time of disability and the expected normal retirement age.

Accordingly, there exists a need for systems and methods to implement improvements in administration of deferred compensation contribution plans and in particular 401 (k) plans to address the potentially staggering loss caused by a long-term disability.

### SUMMARY

The present invention solves the shortcomings of the prior art by providing a novel computer based system and method for administering a defined contribution retirement plan financial product that provides a complete retirement benefit to an employee at normal retirement age notwithstanding any long term disability of such employee during the span of his or her working career. The product also is designed to facilitate satisfaction of the fiduciary requirements set forth in ERISA Section 404(c) (29 U.S.C. §1104).

In particular, a computer network system for administering a retirement plan financial product is provided that includes a disability insurance contract that is for the benefit of retirement plan participants. A disability insurance contract insures a participant under a retirement plan against the inability to continue retirement plan contributions due to disability. Premiums due under the insurance contract are paid from funds in a trust. The benefits paid under a disability insurance contract are paid into the trust and further allocated to participants' accounts. Further, the benefits paid under the insurance contract are not distributable to the insured participant until the participant is eligible to receive plan distributions as a result of attaining normal retirement age as defined in the retirement plan.

Also contained within this disclosure is a method and system to compensate for lost opportunity to contribute pre-taxed money to a deferred taxation retirement plan as a result of disability of a plan participant.

### BRIEF DESCRIPTION OF THE DRAWINGS

FIG. 1 is a block diagram of an exemplary network that may incorporate the systems and methods described herein;

FIGS. 2A-B is a sample flow diagram of a method within this disclosure;

FIG. 3 illustrates an example of possible types of tabular input data used within a method and system within this disclosure;

FIGS. 4A-B illustrates an example of possible tabular data used within a method and system within this disclosure;

FIGS. 5A-D illustrates examples of tabular data pertaining to a computer system methodology within this disclosure;

FIGS. 6A-C illustrates an example of input and output data pertaining to a computer system methodology within this disclosure;

FIGS. 7A-C illustrates an alternate example of input and output data pertaining to a computer system methodology within this disclosure; and

### DETAILED DESCRIPTION

There are numerous tabular information categories that serve as inputs to the technology of this disclosure. A pension disability insurance contract has a variety of optional features, including elimination periods, “own occupation” periods, and cost of living adjustments that apply to the benefit amounts that can be selected by a retirement plan trustee for the benefit of retirement plan participants as contemplated by this disclosure.

Based upon morbidity, expense and other assumptions in the pension disability insurance contract that are determined by an insurance company, resulting computer-generated insurance premiums will meet the insurance company's product designs, underwriting guidelines and desired profit objectives. Additionally within this disclosure, trustees associated with Defined Contribution retirement plans fulfill their fiduciary responsibility under Section 404C of the Internal Revenue Code by evaluating and subsequently inserting the cost of a self-completing pension plan feature in their plans for the benefit of retirement plan participants.

The technology within this disclosure can take the form of an entirely hardware embodiment, an entirely software embodiment or an embodiment containing both hardware and software elements. In one embodiment, the technology is implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital versatile disk (DVD). Both processors and program code for implementing, each as an aspect of the technology, can be centralized or distributed (or a combination thereof) as known by those skilled in the art.

A data processing system suitable for storing and executing program code will include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable moderns and Ethernet cards are just a few of the currently available types of network adapters.

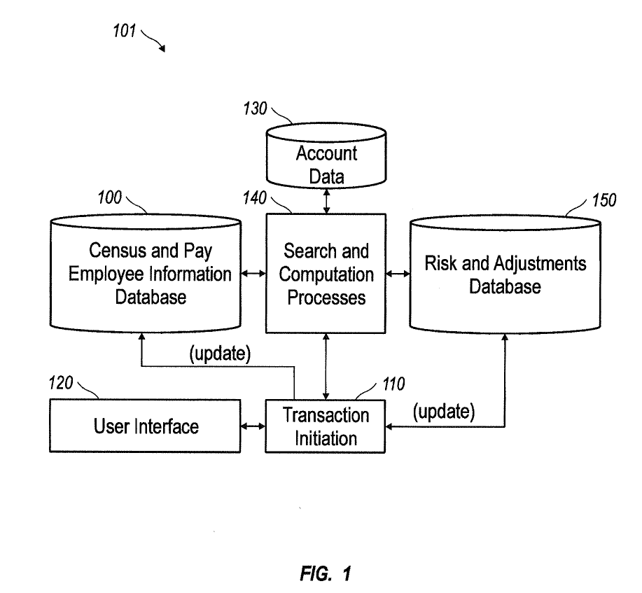

FIG. 1 shows a block diagram of a network within one possible embodiment of this disclosure. Within this disclosure, employee information for each of an entity's employees is stored within at least one data base 100 residing within the memory of one or more computer systems. The employee information includes at least the name, address, birth date, date of hire, occupation and job classification for each employee. In the embodiment disclosed within FIG. 1, the database containing employee information 100 is called a “Census and Pay” database 100, though those skilled in the art will recognize that other titles are possible. Those skilled in the art will also appreciate that the Census and Pay database 100 may comprise one or more sub-data bases. The Census and Pay database 100 is updated at least once each month. Updating may occur as a result of a transaction initiated 110 by a user via a user interface 120. A user interface 120 may be a keyboard and/or mouse, though any mechanism by which a user may enter data will fall within this disclosure.

FIG. 1 shows another database entitled “Risk and Adjustments” database 150. The Risk and Adjustments database 150 may comprise one or more subset databases. At least some of the information that is stored in the Risk and Adjustments database 150 may be proprietary in nature, for example Disability Morbidity Rates, Industry adjustment factors, and Job Classification adjustment factors.

FIG. 1 shows still another database entitled Account database 130. The Account database 130 contains information which will be general to an insurance company as a whole, such as premium taxes, commissions, and administrative and claim adjudication expenses associated with pension disability insurance products offered by the insurance company. The information in the Account database 130 will be established at the inception of a pension disability insurance product within this disclosure, though it may be updated according to the evolving circumstances of the insurance company that establishes and continues to offer the pension disability insurance product. For example, taxes imposed on premiums may change as laws change, and those skilled in the art will recognize that such information will need to be maintained as current.

The example within FIG. 1 discloses that search, retrieval and computation processes 140 are performed between and amongst the various databases 100, 130 and 150. The search, retrieval and computations 140 are performed by at least one computer program product using a data processing system like the one described hereinabove. As shown in FIG. 1, the search, retrieval and computations result from the occurrence of a transaction initiation 110. A transaction initiation 110 may be the result of a user prompting at the user interface 120. A transaction initiation could also occur automatically (not shown) based on the programming of the computer program product.

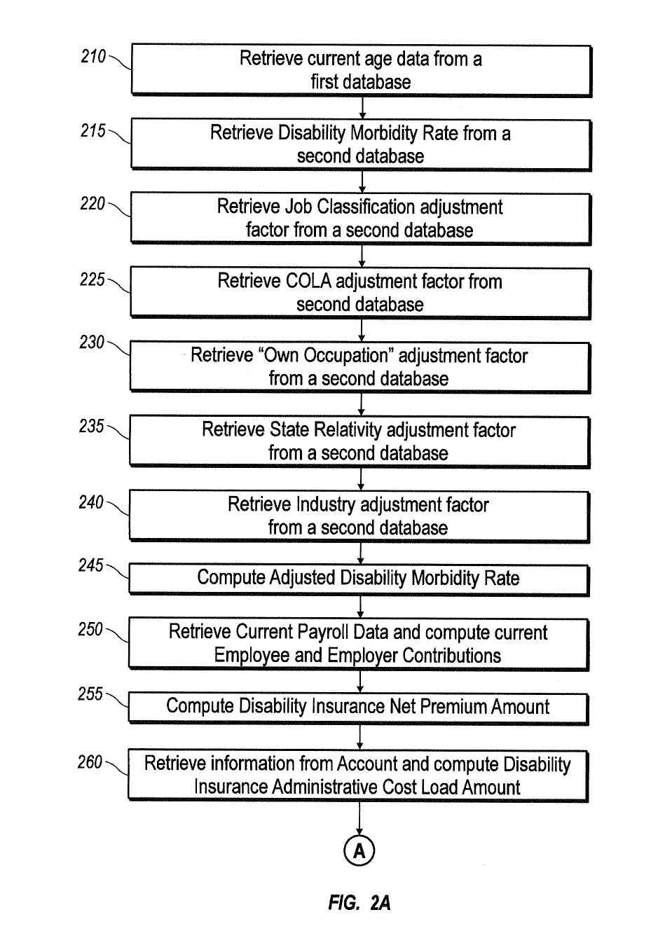

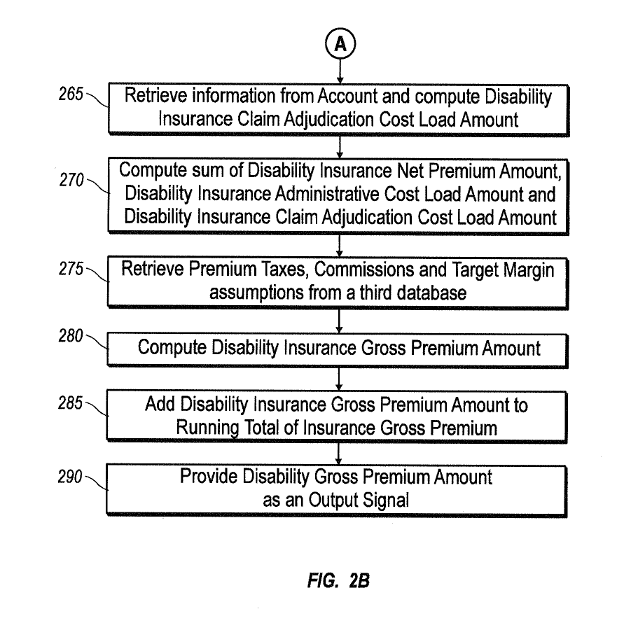

FIG. 2 depicts an exemplary method within this disclosure. The method will be performed at least one time each month for each employee participating in the pension disability insurance program. The computer program product disclosed will retrieve employee information 210 for a pension disability insurance program participant from a first database 100. The employee information may include a participant's name, address, date of birth, the date when the participant was hired (hire date), and the participant's occupation. The computer program product will search 215 a second data base 150 for relevant risk and adjustment factors. For example, the computer program product will retrieve 215 a Disability Morbidity Rate from a second database 150. The computer program product will retrieve 220 a Job Classification adjustment factor from a second database 150. The computer program product will retrieve 225 a Cost Of Living Adjustment factor (aka COLA) from a second database 130. The computer program product will retrieve 230 an “Own Occupation” adjustment factor from a second database 150. Those skilled in the art will recognize that the value for such a factor will depend on whether the participant is insured to recover against the financial impact of the inability to perform his or her particular own occupation due to disability, or whether the participant is insured against the financial impact of the inability to perfoi any occupation due to disability.

Continuing with the exemplary method shown in FIG. 2, the computer program product will retrieve 235 a value for a State Relativity adjustment factor from a second database 150. A State Relativity adjustment factor is an example of proprietary information, and those skilled in the art will recognize that a State Relativity adjustment factor allows for adjustment of insurance premiums charged based on the relative riskiness arising from residence in the various states within the United States of America. A computer program product will retrieve 240 an Industry adjustment factor from a second database 150. Those skilled in the art will recognize that an Industry adjustment factor allows for adjustment of insurance premiums based upon the relative risk associated with various industries that employers operate within. The computer program product in the exemplary method applies said above listed factors to the Disability Morbidity Rate and computes 245 an adjusted disability morbidity rate and stores the Adjusted Disability Morbidity Rate in memory. The computer program product retrieves payroll data from a first database 100. The computer program product applies 250 the Adjusted Disability Morbidity Rate to the retrieved payroll data and thereby outputs Employer and Employee Contributions. The value of the Employer and Employee Contributions is stored in a third database 130. The computer program product applies the Adjusted Disability Morbidity Rate to the Employer and Employee Contribution data from the first database 100 and computes 255 a Disability Insurance Net Premium Amount.

Continuing with the example disclosed in FIG. 2, the computer program product retrieves 260 monthly administrative cost load information from a third database 130 and computes a Disability Insurance Administrative Cost Load Amount. The computer program product applies 265 a claim adjudication cost load to a Disability Insurance Net Premium Amount as described above and outputs a Disability Insurance Claim Adjudication Cost Load Amount. The computer program product computes 270 the sum of Disability Insurance Net Premium Amount, Disability Insurance Administrative Cost Load Amount and Disability Insurance Claim Adjudication Cost Load Amount. The computer program product retrieves 275 account data from an Account database 130 such as values for premium taxes, commissions and target margin assumptions, and adds them in a sum. These terms will be well understood by those in the art. As shown in FIG. 2, the computer program product computes 280 an annual Disability Insurance Gross Premium Amount. The annual Disability Insurance Gross Premium Amount is the sum of the Disability Insurance Net Premium Amount, Disability Insurance Administrative Cost Load Amount and Disability Insurance Claim Adjudication Cost Load Amount, all divided by (one minus a percentage of premium). The computed value for the annual Disability Insurance Gross Premium Amount is then output and can be stored in memory.

The computed value generated by the method for annual Disability Insurance Gross Premiums for all participants in a plan can be totaled and used to compute an annual Disability Insurance Gross Premium Amount for the plan, in other words to create a running total of insurance gross premium 285. A disability gross premium amount can then be outputted as a signal 290. A benefit of the system 101 within this disclosure is that an annual Disability Insurance Gross Premium Amount can be used by the plan trustee on an ongoing or continuing basis to evaluate whether the pension disability insurance plan allows the trustee to meet its fiduciary duty to the retirement plan participants.

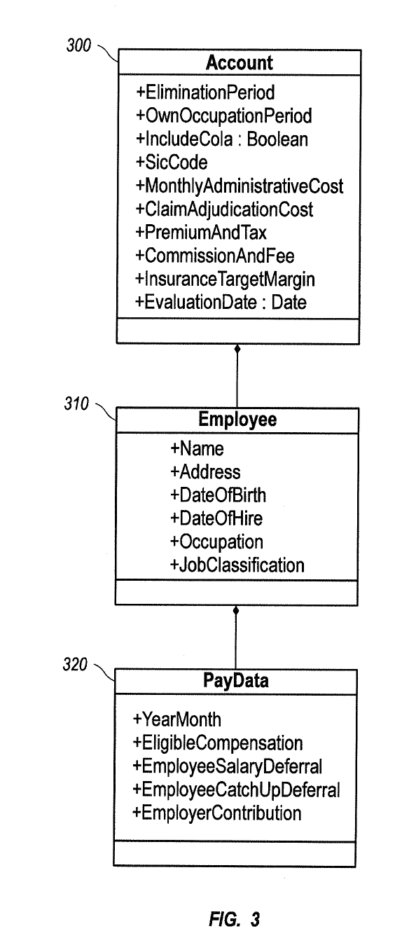

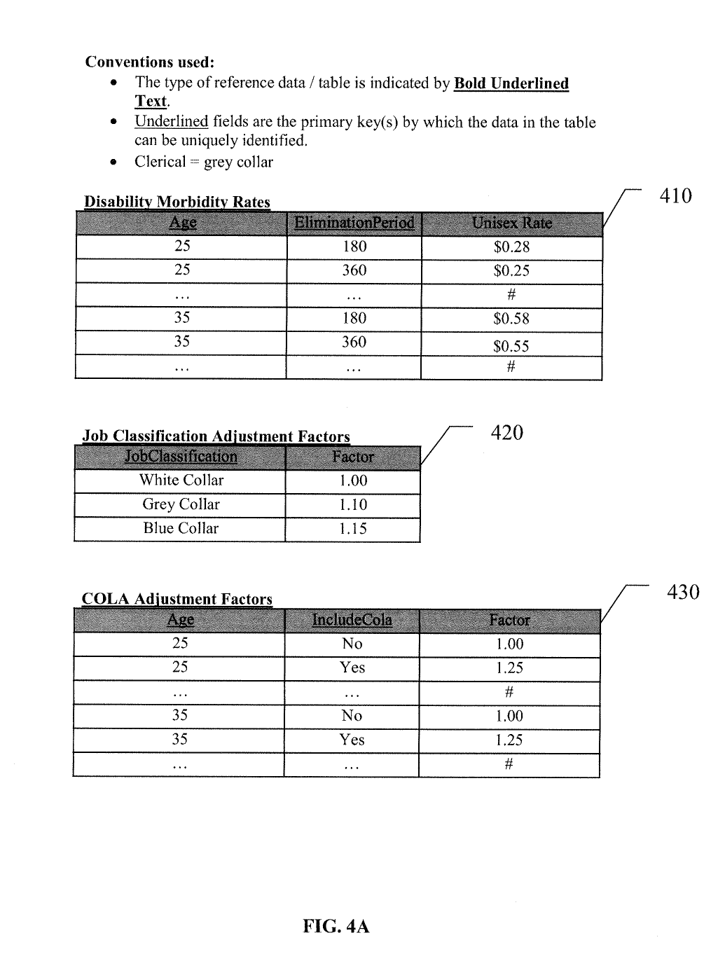

With regard to the exemplary types of data shown in FIG. 3, account data 300, employee data 310 and pay data 320, the following functions, processes, and calculations can be used to apply the basic principles within this disclosure to plan administrative processes: compute the current age of a participant; retrieve a relevant unisex morbidity rate from a computer database correlated to age and an elimination period (the period of continuous disability before benefits begin); retrieve a job classification adjustment factor from a computer database; retrieve a cost of living adjustment (COLA) factor from a database such as the Risk and Adjustments Database 150; retrieve an “Own Occupation” Adjustment Factor from a database such as the Risk and Adjustments Database 150; retrieve a State Relativity Adjustment Factor from a database such as the Census and Pay Employee Information Database 100 and retrieve an Industry Adjustment Factor based on Standard Industrial Classification (aka SIC) from a database such as the Risk and Adjustments Database 150.

Using data retrieved as described above, the system 101 can be used to compute an Adjusted Annual Unisex Disability Morbidity Rate, which can be stored in a database such as Account Data 130 for later retrieval during a search and computation process 140. The data retrieved and stored according to the methods above can be used to calculate values for employee and employer contributions. Having done so, the system 101 multiplies the contributions by the adjusted morbidity rate. Said value divided by 100 is then a disability net premium. The method will then store the disability net premium in one or more databases, for example the Account Data database 130 for later retrieval. The system 101 will then compute Disability Insurance claim adjudication cost loads using the type of data shown in the exemplary Expense Assumptions Table 520 according to the methods disclosed (net premium times claims cost load, where claim cost load is defined by the user of the system 101). The system 101 can then be used to compute Disability Insurance claim adjudication cost loads using the type of data shown in the exemplary Expense Assumptions Table 520 according to the methods disclosed. The system 101 can then be utilized to compute the sum of the Net Premium and non-volume related expense data and this data will be stored in a database. The system 101 can then be used to compute an Annual Disability Insurance Gross Premium Amount using the type of data stored in Account Data 130 and shown in the example Expense Assumptions table 520.

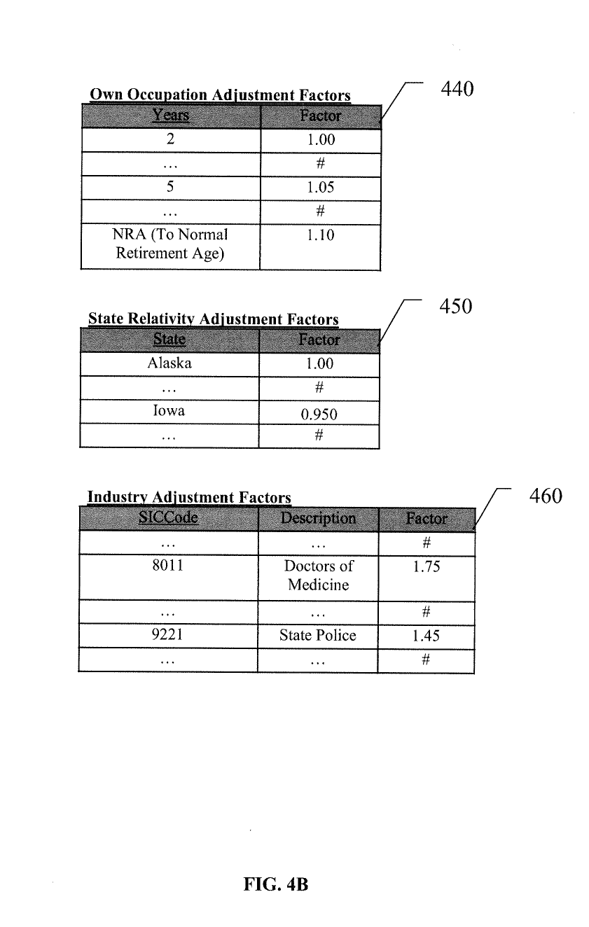

FIG. 4A contains three exemplary tables of information used in implementing the system 101 disclosed. The Disability Morbidity Rates table 410 shows possible disability morbidity rates based on age which are stored in a database like the Risk and Adjustments Database 150. The Job Classification Adjustment Factors table 420 shows exemplary job classification modifiers of the type that are stored in a database such as the Risk and Adjustments Database 150. The COLA Adjustment Factors table 430 shows exemplary cost of living adjustments data of the type that is stored in the Risk and Adjustments Database 150.

In FIG. 4B, the Own Occupation Adjustment Factors table 440 shows exemplary own occupation data of the type that is stored in the Risk and Adjustments Database 150. The State Relativity Adjustment Factors table 450 shows exemplary state relativity adjustment factors of the type that are stored in the Risk and Adjustments Database. In the example shown, it can be seen that Alaska (1.00) as a state of residence is considered to be of higher risk of disability than Iowa (0.95). The Industry Adjustments Factors table 460 shows possible SIC Codes and accompanying factors as described above.

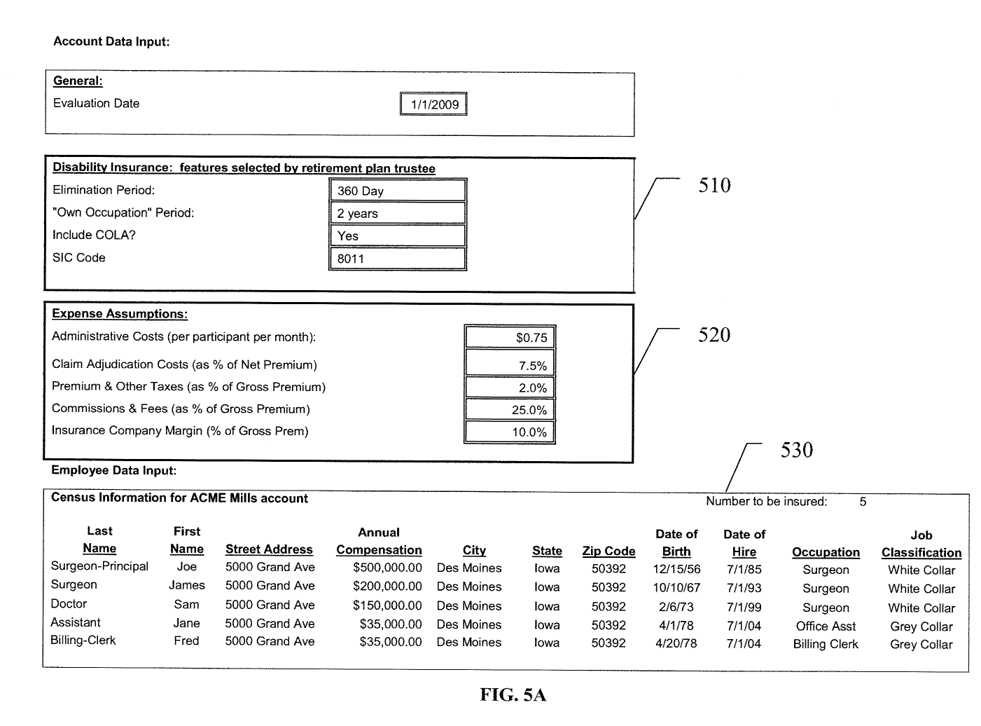

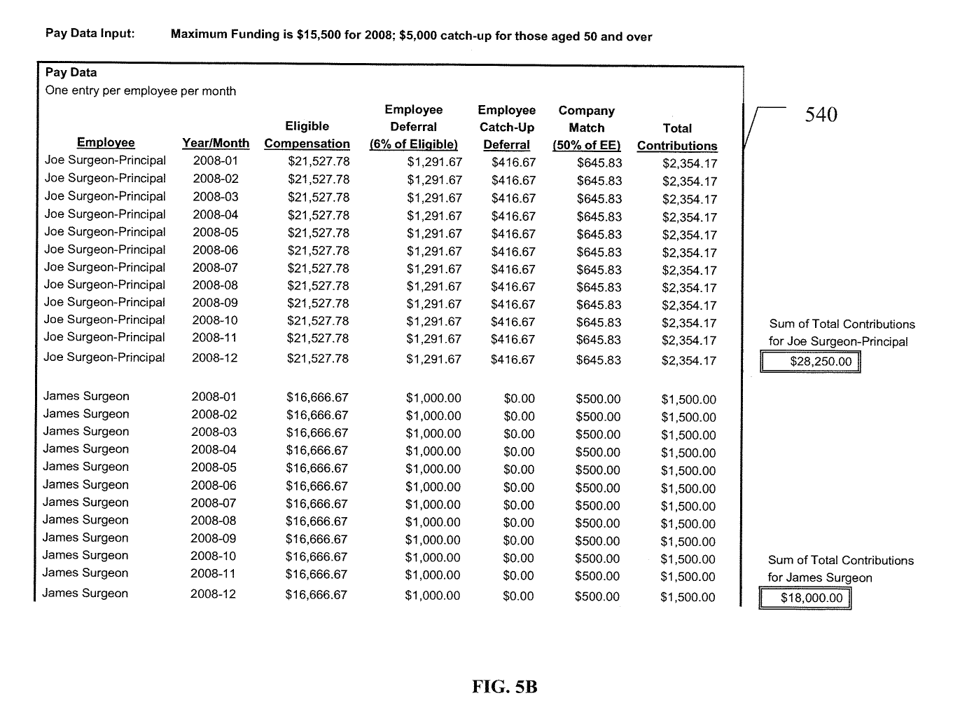

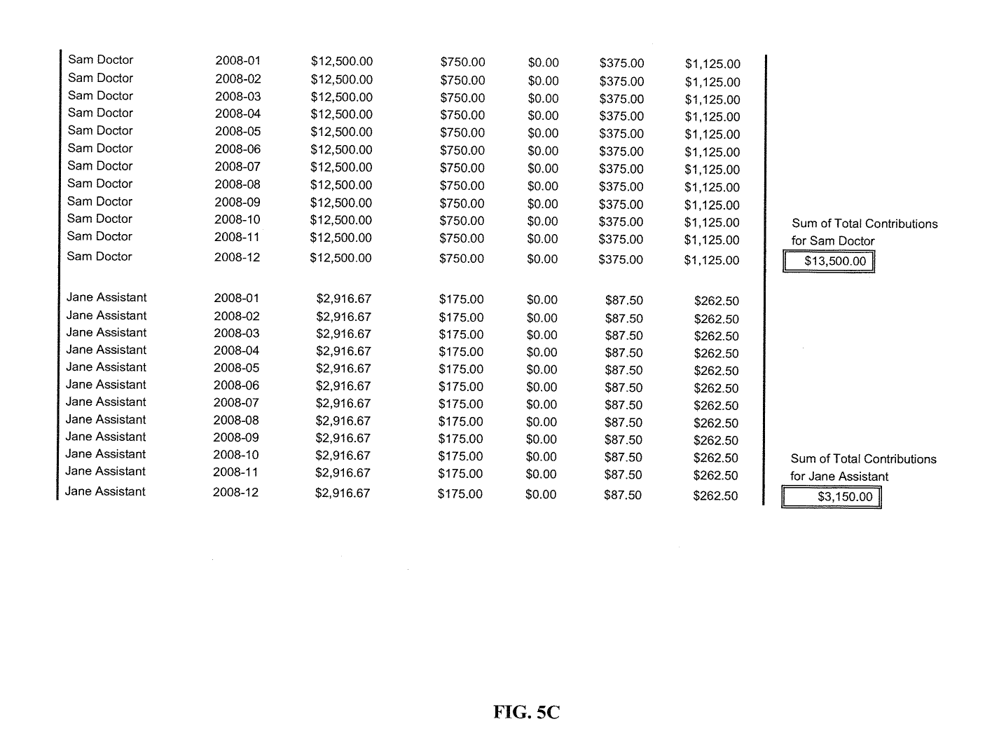

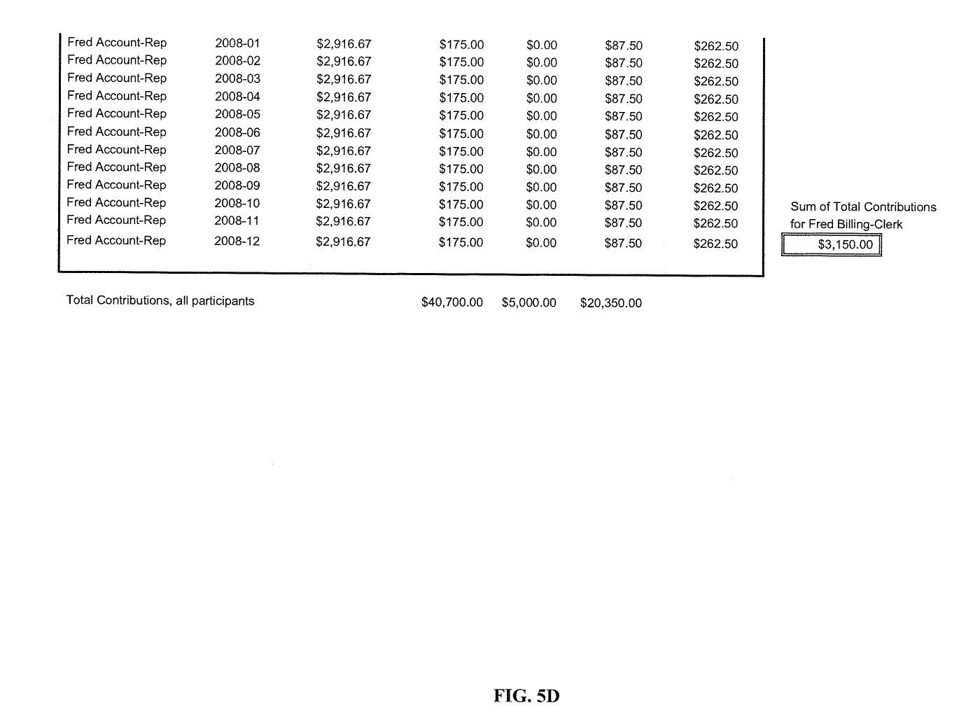

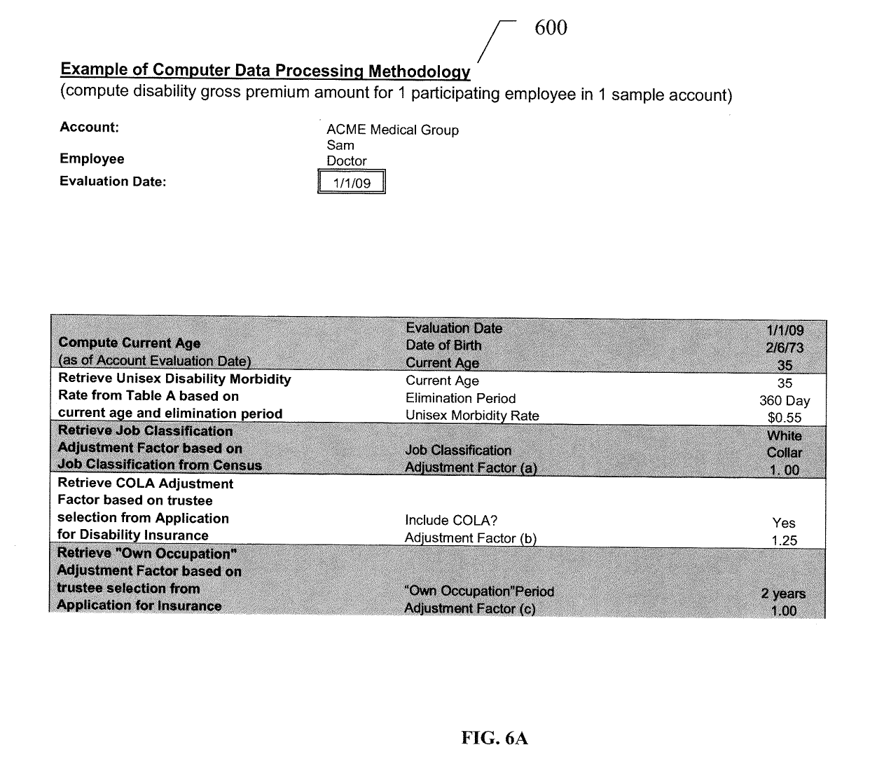

FIGS. 5A-D contains several tables representing input and output data according to the method herein. The Disability Insurance table 510 shows data elected by the plan trustee and stored in a database like Account Data 130. Those skilled in the art will recognize that the data in the table 510 are exemplary only. As previously discussed the Expense Assumptions table contains data of a type which may be stored in a database like Account Data 130. The Census Information table 530 contains census information for five hypothetical persons that would be stored in a database like the Census and Pay Employee Information Database 100. FIG. 5B contains a Pay Data table 540 showing exemplary tabulated pay data and resultant associated calculated contributions according to the method for the five hypothetical persons shown in the Census Information table 530.

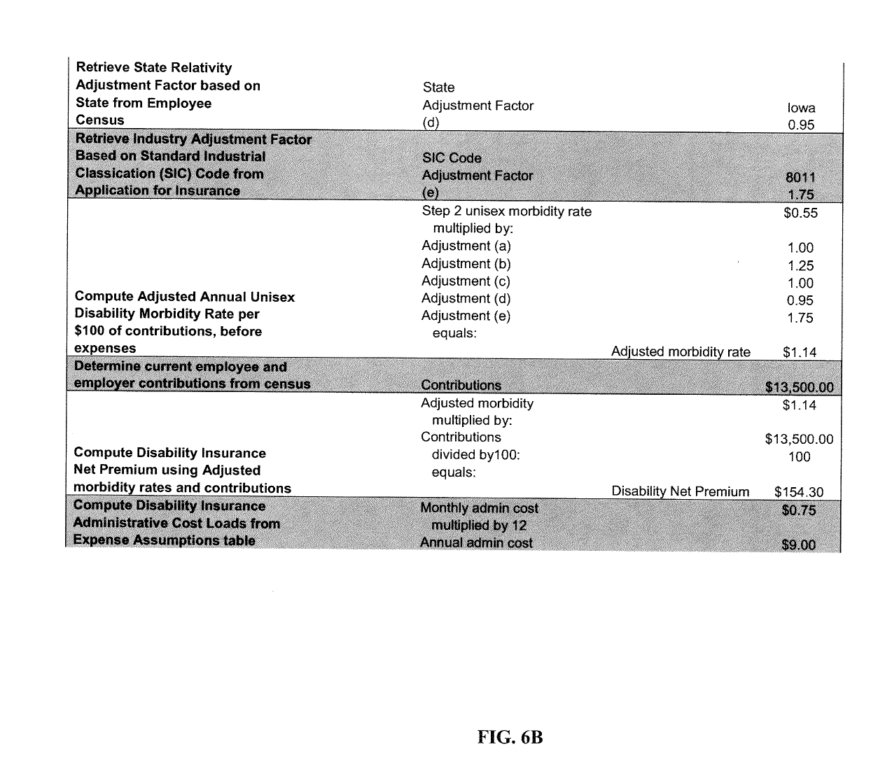

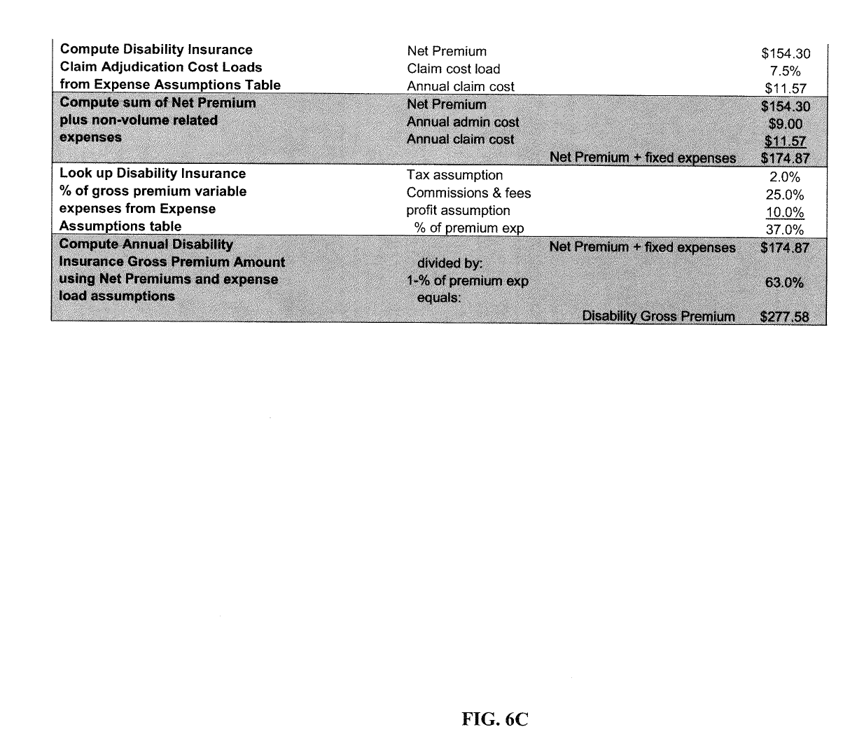

FIGS. 6A-C shows a table entitled computer data processing methodology 600. The table 600 shows exemplary input and output values produced and stored by the system 101 for one hypothetical individual listed in the Census Information table 530.

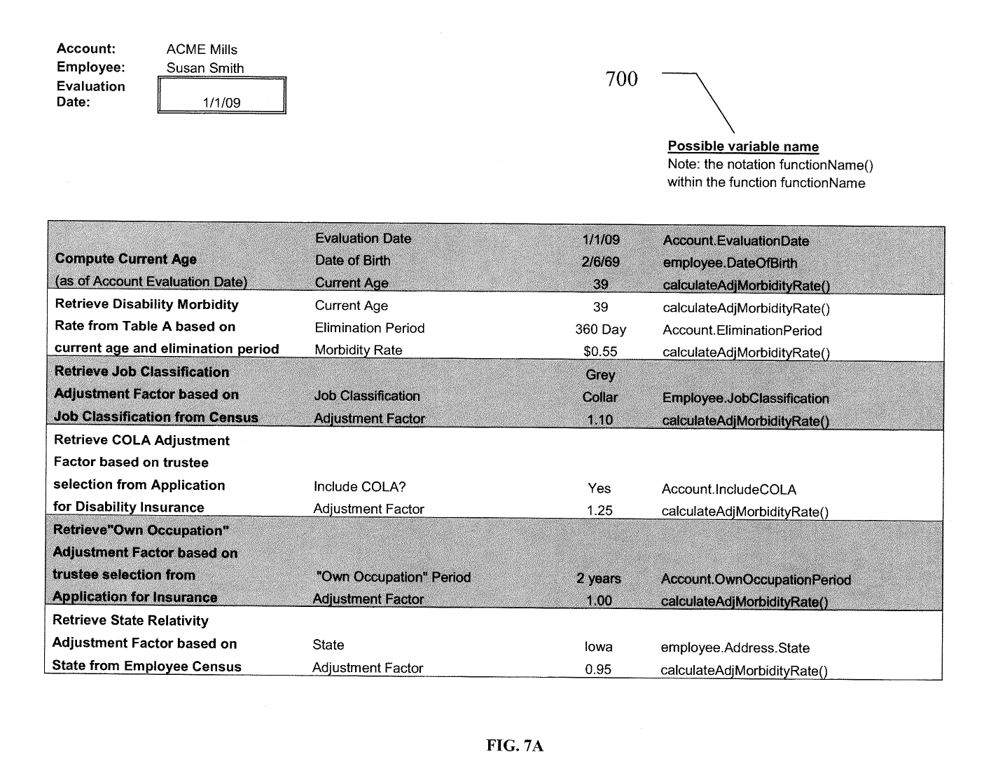

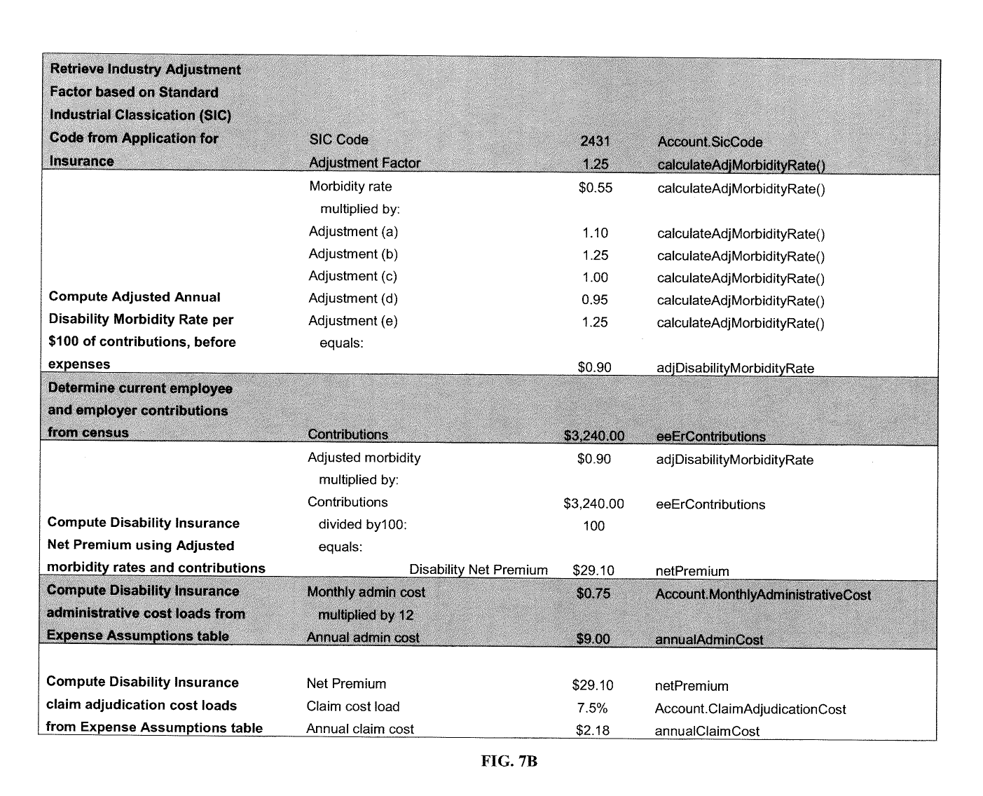

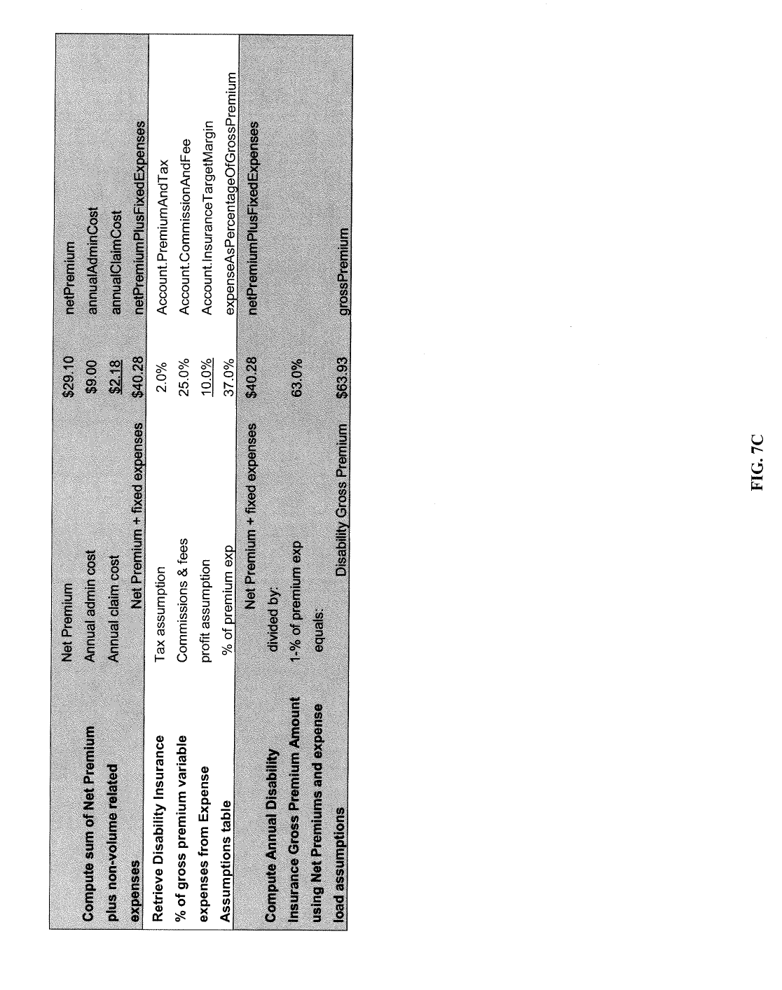

FIGS. 7A-C shows possible input and output values for another hypothetical individual listed in the Census Information table 530. The right hand column 700 of FIGS. 7A-C shows possible variable names, as will be discussed below, for variables associated with the data listed in the middle column of FIGS. 7A-C and retrieved from the databases according to the method herein.

Exemplary code for programming a computer within this disclosure is shown in Table 1. Those skilled in the art will recognize that other variations of this code are possible while still falling within this disclosure. The code or instructions can be written in procedural, database, objected oriented, or other equivalent computer language.

TABLE 1
SCPP Main Program Logic{

/*Function names beginning with “get” indicate a lookup from a reference source
Function names beginning with “calculate” indicate that a calculation is being performed.
Account data will be entered via the UI and/or loaded from file.
The following line will load the Account's data, plus data for the employee(s) and
employee pay data. Note that data for the Account may be retrieved from multiple
internally or externally hosted data sources, and may be loaded up-front (using eager
fetching), or on-demand (using lazy loading) as needed.*/

Account = loadCurrentAccount( );
decimal totalGrossPremium = 0
/*This will cycle through each employee in the census and calculate the

premium for each employee. Once an employee's premium is calculated, it will be added
to the running premium total. The policy premium will be the sum of the

premium values calculated for each employee.*/
foreach (employee in Account.Employees)
{ decimal adjUnisexMorbidityRate =

calculateUnisexMorbidityRate(employee);

decimal eeErContributions =

sumEmployeeContributionTotals(employee);

decimal netPremium =

calculateDisabilityNetPremium(adjUnisexMorbidityRate, eeErContributions);

decimal annualAdminCost =

Account.MonthlyAdministrativeCost * 12;
//Annualize the monthly admininstrative costs.
//Note that ClaimAdjudicationCost (below) is a load factor entered as a percent.

decimal annualClaimCost = netPremium *

Account.ClaimAdjudicationCost;

decimal netPremiumPlusFixedExpenses = netPremium +

annualAdminCost + annualClaimCost;

decimal expenseAsPercentageOfGrossPremium =

calculateExpenseAsPercentageOfGrossPremium( );
//the grossPremium figure is the gross premium for an employee.

decimal grossPremium =

calculateGrossPremium(netPremiumPlusFixedExpenses,
expenseAsPercentageOfGrossPremium);

//The following line takes this employee's gross premium amount and adds it to the
running premium total

//for all employees.
totalGrossPremium += grossPremium;

}
//This is the end of the program and the totalGrossPremium dollar will be

output as the final total for all employees.

Display( totalGrossPremium );

}

/*This method looks up rating adjustment values from several sources. It then multiplies
each item together to arrive at an adjusted Unisexmorbidiy rate. Each of the calls listed
below that begin with the word ‘get’ indicates a request to obtain data from a data
repository. Each of the parameters passed in the ‘get’ calls will be used to look data up
from the repository. For example, the employee.JobClassification will look up a rate
from the datasource and the proper rate will be returned based upon a matching value in
the repository for the JobClassification.*/

decimal calculateUnisexMorbidityRate(employee) {

int currentAge = calculateCurrentAgeInYears(employee.DateOfBirth);
decimal unisexMorbidityRate = getUnisexMorbidityRate(currentAge,

Account.EliminationPeriod);

decimal jobClassAdjFactor =

getJobClassAdjFactor(employee.JobClassification);

decimal colaAdjFactor = getColaAdjFactor(currentAge,

Account.IncludeCola);

decimal ownOccupationAdjFactor =

getOwnOccupationAdjFactor(Account.OwnOccupationPeriod);

decimal stateRelativityAdjFactor =

getStateRelativityAdjFactor(employee.Address.State);

decimal industryAdjFactor = getIndustryAdjFactor(Account.SicCode);
return (unisexMorbidityRate * jobClassAdjFactor * colaAdjFactor *

ownOccupationAdjFactor * stateRelativityFactor * industryAdjFactor);

}

/*Note that ageInYears is calculated using the Account.Evaluation date and not the
current date. This ensures consistent results when the program is run from day to day. It
avoids the possibility that a change in the current date might cause the premiums to vary
because an employee had a birthday between the dates the calculation was run.*/
int calculateCurrentAgeInYears(employee.DateOfBirth) {
int years = Account.EvaluationDate.Year − employee.DateOfBirth.Year;

if (Account.EvaluationDate.Month < employee.DateOfBirth.Month ||

(Account.EvaluationDate.Month == employee.DateOfBirth.Month &&
Account.EvaluationDate.Day < employee.DateOfBirth.Day))

--years;

return years;

}

/*Takes the adjusted Unisex morbidity rate, multiplies it times the sum of the employee's
contributions and divides by 100 to arrive at the net premium.*/

decimal calculateDisabilityNetPremium(adjUnisexMorbidityRate,

eeErContributions){

return (unisexMorbidityRate * eeErContributions) /100;

}

//Note that each of the values below has been entered as a percentage. The resultant sum
will be returned as a percentage.

decimal calculateExpenseAsPercentageOfGrossPremium( ) {

return (Account.PremiumAndTaxes + Account.CommissionAndFee +

Account.InsuranceTargetMargin);

}

/*Takes the netPremiumPlusFixedExpenses dollar amount and divides it by 1 minus the
expense percentage. If the expenseAsPercentageOfGrossPremium figure was 37%, the
calculation would be the netPremiumPlusFixedExpenses / .63 */

decimal calculateGrossPremium(netPremiumPlusFixedExpenses,

expenseAsPercentageOfGrossPremium) {

return (netPremiumPlusFixedExpenses / (1 −

expenseAsPercentageOfGrossPremium));

}

/*This calculation sums each pay data value for each employee. Normally, each
employee will have one pay data record per month, and there will be 12 months of data
for each employee. This will sum the values for the Employee Salary Deferral, the
Employee CatchupDeferral and the Employer Contribution for each month and returns a
sum for the combined data for all the months.*/

decimal sumEmployeeContributionTotals(employee){

decimal payTotal = 0;
foreach (payData in employee.PayData){
{

payTotal += payData.EESalaryDeferral +

payData.EECatchUpDeferral + ERContribution;

}
return payTotal;

}

I claim:

1. A computer implemented method for preventing financial loss, the computer implemented method comprising:
maintaining, on a processor, a disability insurance contract that is owned by a retirement plan trust, exists for benefit of retirement plan participants, and which insures a participant under the disability insurance contract against the inability to continue retirement plan contributions due to disability, and protects a fiduciary from liability due to lost retirement benefits; and
receiving, on the processor, at least the following information:
the participant's account information;
the participant's employment information; and
the participant's pay data; and
based on said information, outputting, by the processor, to a computer data base and a computer display communicatively coupled to said processor:
a disability benefit amount under the disability insurance contract; and
a scheduling of benefits paid into the trust according to the disability insurance contract;
wherein:
premiums due under the disability insurance contract are paid from funds in the trust;
benefits paid under the disability insurance contract are paid into the trust and further allocated to participants' accounts; and
distributing benefits to the participant when the participant is eligible to receive plan distributions as a result of attaining normal retirement age as defined in the disability insurance contract.

2. The computer implemented method of preventing financial loss according to claim 1, wherein the computer implemented method of preventing financial loss complies with the Employee Retirement Income Security Act.

3. The computer implemented method of preventing financial loss according to claim 1, wherein said disability insurance contract is a group disability contract, with participants in said retirement plan being members of the group.
